(19) United States
(12) Patent Application Publication
(10) Pub. No.: US 2015/0278055 A1
(43) Pub. Date: Oct. 1, 2015

(54) PLUGGABLE COMPONENT TRACKING PROGRAM

(71) Applicant: International Business Machines Corporation, Armonk, NY (US)

(72) Inventors: Tu T. Dang, Cary, NC (US); Michael C. Elles, Apex, NC (US); Paul Klustaitis, Durham, NC (US); Mark G. Noll, Raleigh, NC (US); Luis R. Quinones, Raleigh, NC (US)

(73) Assignee: International Business Machines Corporation, Armonk, NY (US)

(21) Appl. No.: 14/228,497

(22) Filed: Mar. 28, 2014

(51) Int. Cl. G06F 11/22; G06F 11/30

(52) U.S. Cl. CPC G06F 11/2289; G06F 11/3051; G06F 11/2205

(57) ABSTRACT

A method for tracking a pluggable component associated with an electronic device is provided. The method may include identifying at least one field of vital product data (VPD) information associated with the pluggable component. The method may also include decoding the at least one field of VPD information. Additionally, the method may include determining, based on the decoding of the at least one field, when a hardware id associated with the pluggable component is valid. The method may further include generating a pairing signature based on the hardware id being valid.

### BACKGROUND

The present invention relates generally to the field of computing, and more particularly to tracking pluggable hardware components.

During warranty repairs for electronic devices, it is may often be challenging for hardware vendors to determine if pluggable components present within an electronic device may be eligible for warranty work since many pluggable components may carry separate warranty terms from the host electronic device. Pluggable components may be swapped or moved among systems containing different warranty terms, or may be acquired from the gray market and installed in an electronic device eligible for warranty work. Due to the difficulty in tracking pluggable components, the current warranty support model may have loopholes in granting warranty work on electronic devices since the original pluggable component may no longer reside in the electronic device.

### SUMMARY

Therefore it may be advantageous, among other things, to provide one or more exemplary embodiments associated with the tracking and identifying of pluggable components.

According to one exemplary embodiment, a method for tracking a pluggable component associated with an electronic device is provided. The method may include identifying at least one field of vital product data (VPD) information associated with the pluggable component. The method may also include decoding the at least one field of VPD information. Additionally, the method may include determining, based on the decoding of the at least one field, when a hardware id associated with the pluggable component is valid. The method may further include generating a pairing signature based on the hardware id being valid.

According to another exemplary embodiment, a computer system for tracking a pluggable component associated with an electronic device is provided. The computer system may include one or more processors, one or more computer-readable memories, one or more computer-readable tangible storage medium, and program instructions stored on at least one of the one or more tangible storage medium for execution by at least one of the one or more processors via at least one of the one or more memories, whereby the computer system is capable of performing a method. The method may include identifying at least one field of vital product data (VPD) information associated with the pluggable component. The method may also include decoding the at least one field of VPD information. Additionally, the method may include determining, based on the decoding of the at least one field, when a hardware id associated with the pluggable component is valid. The method may further include generating a pairing signature based on the hardware id being valid.

According to yet another exemplary embodiment, a computer program product for tracking a pluggable component associated with an electronic device is provided. The computer program product may include one or more computer-readable storage medium and program instructions stored on at least one of the one or more tangible storage medium, the program instructions executable by a processor. The computer program product may include program instructions to identify at least one field of vital product data (VPD) information associated with the pluggable component. The computer program product may also include program instructions to decode the at least one field of VPD information. Additionally, the computer program product may include program instructions to determine, based on the decoding of the at least one field, when a hardware id associated with the pluggable component is valid. The computer program product may further include program instructions to generating a pairing signature based on the hardware id being valid.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2A-2B is an operational flow chart illustrating a process for a pluggable component tracking program according to at least one embodiment; and

FIG. 3 is a block diagram of internal and external components of computers and servers depicted in FIG. 1 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computing, and more particularly to tracking pluggable hardware components. The following described exemplary embodiments provide a system, method and program product for pluggable component tracking.

According to at least one implementation of the present embodiment, pluggable components such as CPUs, PCIe adapters, system memory, storage and optical devices may be tracked by checking if such pluggable components have been added to the electronic device as optional hardware during or after the original sales date. As such, the tracking of pluggable components inside the electronic device may improve the warranty savings since it may help identify the source for the pluggable components as well as its use characteristics over time.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for pluggable component tracking. According to at least one implementation of the present embodiment, a hardware manufacturer may identify and track pluggable components present in an electronic device during the service life associated with the electronic device. This may be implemented by utilizing trusted device id pairing and tracking of the pluggable components over time to prevent unauthorized warranty claims which may not meet the warranty terms as well tracking the pluggable components over the service life of the electronic device.

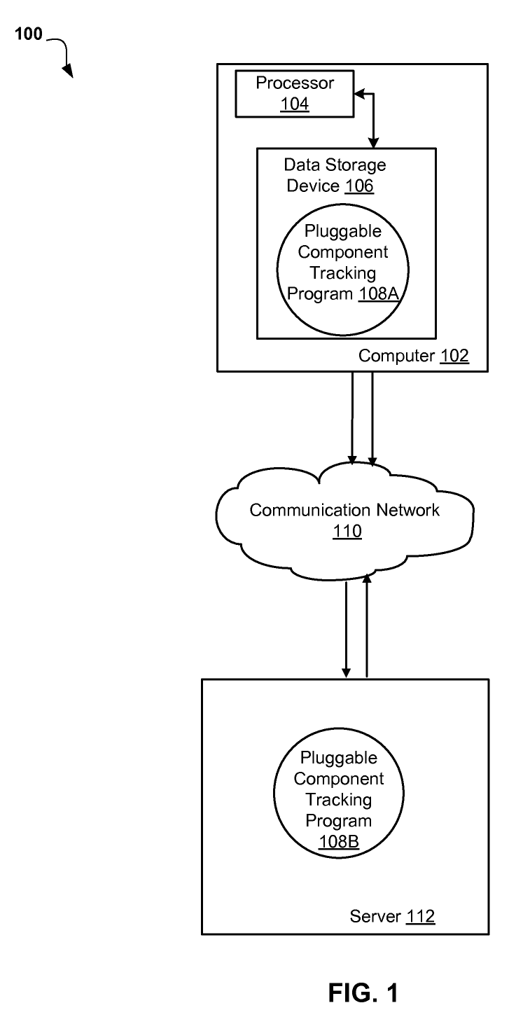

Referring now to FIG. 1, an exemplary networked computer environment 100 in accordance with one embodiment is depicted. The networked computer environment 100 may include a computer 102 with a processor 104 and a data storage device 106 that is enabled to run a pluggable component tracking program 108A. The networked computer environment 100 may also include a server 112 that is enabled to run a pluggable component tracking program 108B and a communication network 110. The networked computer environment 100 may include a plurality of computers 102 and servers 112, only one of which is shown for illustrative brevity. The communication network may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

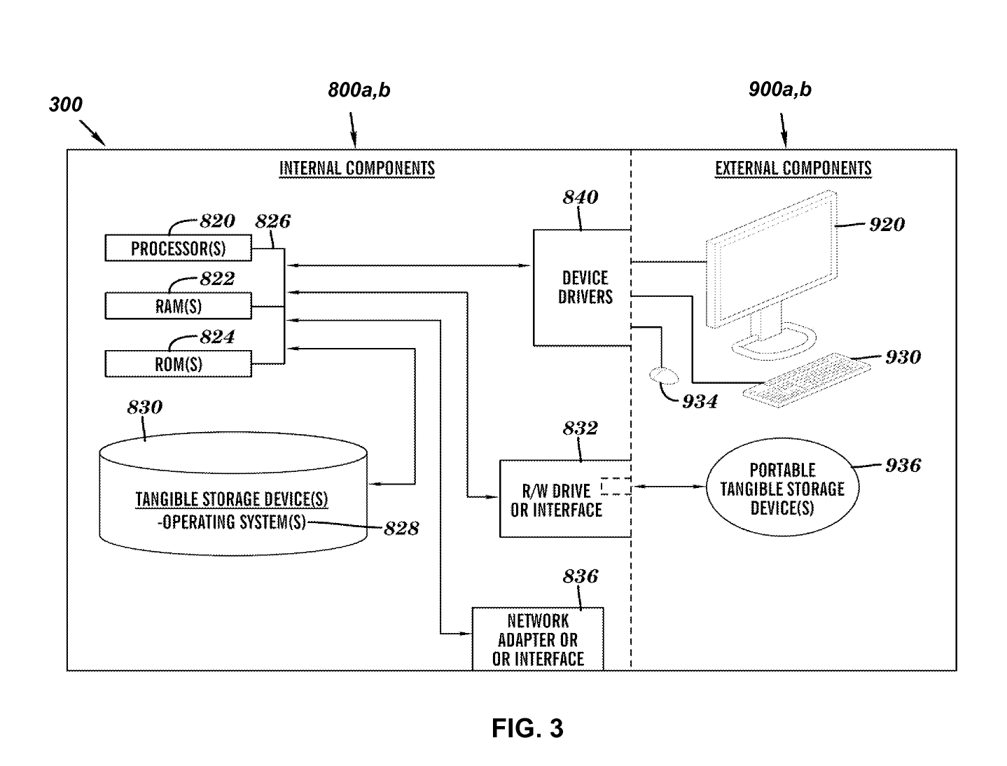

The client computer 102 may communicate with server computer 112 via the communications network 110. The communications network 110 may include connections, such as wire, wireless communication links, or fiber optic cables. As will be discussed with reference to FIG. 3, server computer 112 may include internal components 800a and external components 900a, respectively and client computer 102 may include internal components 800b and external components 900b, respectively. Client computer 102 may be, for example, a mobile device, a telephone, a PDA, a netbook, a laptop computer, a tablet computer, a desktop computer, or any type of computing device capable of running a program and accessing a network.

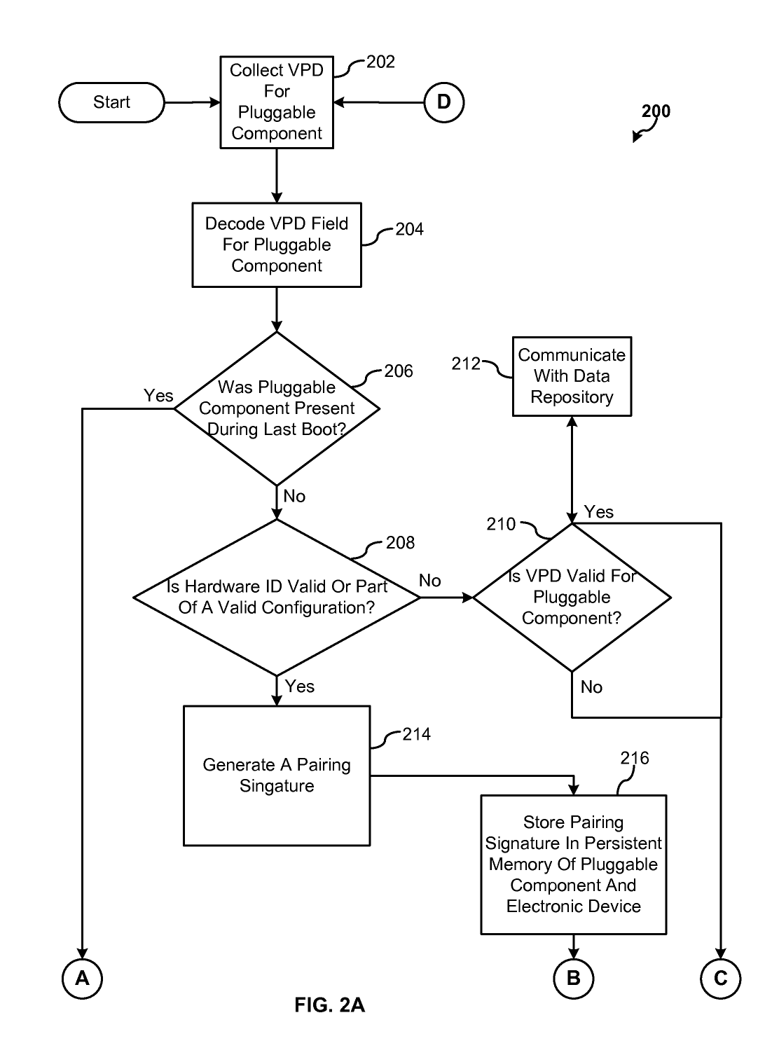

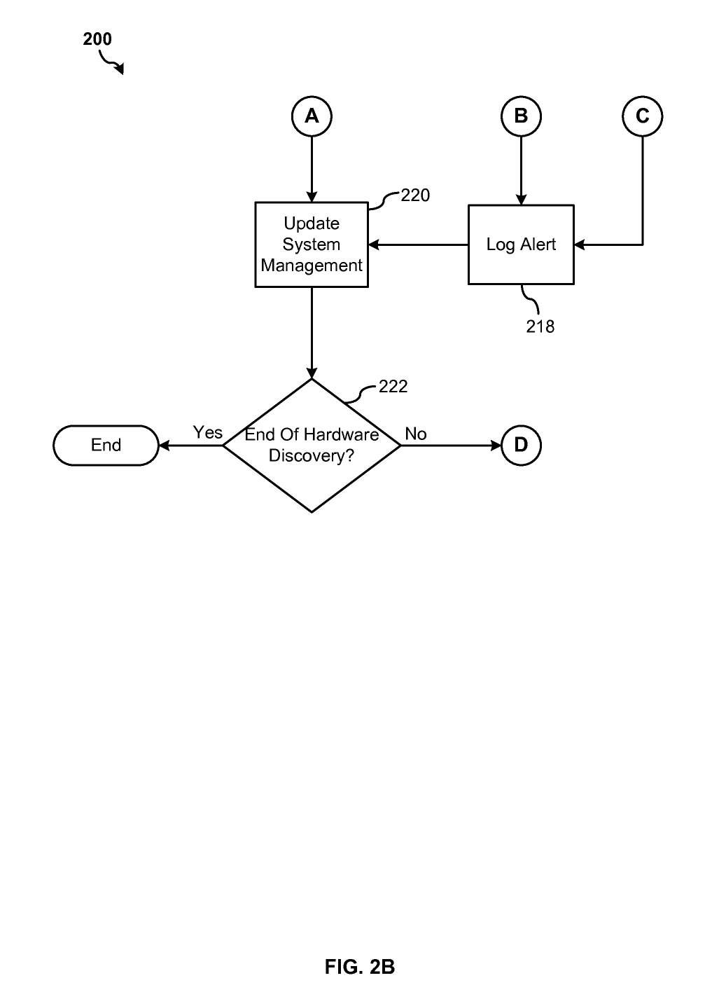

A program, such as a pluggable component tracking program 108A and 108B may run on the client computer 102 or on the server computer 112. The pluggable component tracking program 108A and 108B may be utilized to identify and track pluggable components present in an electronic device during the service life associated with the electronic device. For example, a user using a pluggable component tracking program 108A, running on a client computer 102 may connect via a communication network 110 to server computer 112 which may also be running a pluggable component tacking program 108B. Furthermore, the user using client computer 102 or server 112 may utilize the pluggable component tracking program 108A, 108B to identify and track pluggable components present in an electronic device, such as a computer 102 or a server 112 during the service life associated with the warranty of the electronic device. The pluggable component tracking program is explained in further detail below with respect to FIG. 2.

Referring now to FIG. 2A-B, an operational flow chart illustrating the exemplary process 200 by the pluggable component tracking program 108A and 108B (FIG. 1) according to at least one embodiment is depicted. The process 200 may run on an electronic device such as a server, computer, laptop, smart phone, tablet computer, or other electronic device having one or more pluggable components. The process 200 may be implemented, for example, during the electronic device boot sequence.

At 202, the process 200 collects encoded vital product data (VPD) for a pluggable component that is connected to the electronic device. Examples of pluggable components may include CPUs, PCIe adapters, system memory, hard disk drives, optical disc drives, etc. The VPD may include information such as a component serial number, a manufacturer part number, hardware identification number (hardware ID), or other information specific to the component type. The VPD may also include user-defined information, such as pairing signatures as discussed below. The VPD for a pluggable component may be stored on the pluggable component (e.g., a ROM chip attached to the pluggable component) itself. Then, at 204, the VPD for the pluggable component is decoded. For example, the VPD for the pluggable component may be decoded to extract information, such as the component's serial number, part number, hardware ID, pairing signatures, or other information for later use by the process 200.

Next, at 206, the pluggable component's pairing signature, if present, is checked to determine if the pluggable component was present during the last time the electronic device was booted up. This may be done, for example, by checking the pluggable component's pairing signature against a list of pairing signatures (which may be located on the electronic device) for the pluggable components that were present when the electronic device was last booted up. If, for example, no pairing signature stored on the electronic device from the last boot is found that matches the pluggable device's pairing signature, or if there is no pairing signature found in the VPD of the pluggable component, then the process 200 may determine that the pluggable device was not present during the last boot. If at 206 it is determined that the pluggable component was not present during the last boot, the process 200 proceeds to 208.

If at 206, it is determined that the pluggable component was not present during the last boot, then at 208, the process 200 will determine if the pluggable component's hardware ID is valid or part of a valid device configuration. This determination may be done, according to one implementation, by comparing the hardware ID against a table listing hardware ID information corresponding to valid pluggable components, or against a table listing hardware ID information corresponding to pluggable components that are part of valid electronic device configurations consistent with the warranty terms of the electronic device. The table used to make the above determination may, for example, be managed by and stored in a system management chip located on the planar (e.g., printed circuit board) of the electronic device. According to at least one implementation of the present embodiment, updates to the list of valid hardware IDs and valid device configurations may occur when the electronic device firmware is updated.

If at 208 it is determined that the hardware ID of a pluggable component is not valid or not part of a valid configuration associated with the electronic device, then at 210 the process 200 determines if the VPD is valid for the pluggable component. The process 200 may, according to at least one embodiment, determine if the VPD is valid for the pluggable component by comparing the information contained in the pluggable component's VPD (e.g., a serial number) against a table listing manufacturer rejected components, counterfeit components, components with invalid VPD, etc. The table used to make the above determination may, for example, be managed by and stored in a system management chip located on the planar of the electronic device. The process 200 may also detect an invalid pluggable component if the pluggable component has no VPD.

Next at 212, the pluggable component tracking program 108A, 108B (FIG. 1) may communicate with a data repository to send and store the pluggable component's information (e.g., hardware ID, pairing signatures, etc.) for the original manufacturer to access. According to one implementation, a data repository may be a database located on a server connected via a network or cloud to the electronic device. For example, the pluggable component tracking program 108A, 108B (FIG. 1) may provide information so that the original manufacturer may track the pluggable component since the pluggable component may be transferred to different electronic devices over time. Additionally the pluggable component tracking program 108A, 108B (FIG. 1) may alert the original manufacturer to the presence of pluggable components in an electronic hardware device that may not be covered under warranty prior to warranty service.

Additionally, according to at least on implementation, the information previously discussed with respect to 212 may be stored in a log or other file format locally on the electronic device. The locally stored files may be used, for example, as a backup in the event that the data repository is compromised; if the electronic device loses its connection with the data repository; or if the electronic device is not connected in any way to a remote data repository. The local logs, or other files, may then be accessed by support personnel to assess if the pluggable components in the electronic device are consistent with the terms of the manufacturer's warranty.

However, if at 208, it is determined that the hardware ID for the pluggable component is valid or part of a valid device configuration associated electronic device, then at 214, the process 200 will generate a pairing signature for the pluggable component and the electronic device. According to one implementation, the pairing signature may be generated by utilizing six hexadecimal arguments in the following formula:

Pairing Signature=Checksum*Encryption Key+A₅+A₆

Before the above pairing signature can be calculated, the value for the checksum and encryption key may be determined. According to one implementation, the checksum may be calculated by the following formula:

Checksum=Σ(A₁)XORΣ(A₂)XORΣ(A₃)XORΣ(A₄)

According to one implementation of at least one embodiment, the encryption key can be represented by any hexadecimal value and once the checksum and encryption key are determined, the pairing signature can may be calculated using the previous pairing signature formula. According to one embodiment, the above pairing signature calculation may be performed by a trusted platform module (TPM) located on the planar associated with the electronic device.

The following is an example demonstrating how a pairing signature is generated according to the above implementation:
The first argument A₁is a device serial number (e.g., L3CFK6L or 0x4C3343464B364C in hexadecimal).
The second argument A₂is a device machine type (e.g., 6474 or 0x36343734 in hexadecimal).
The third argument A₃is a pluggable component part number (e.g., 68Y7381 or 0x36385937333831 in hexadecimal).
The fourth argument A₄is a pluggable component serial number (e.g., FC20274005 or 0x46433230323734303035 in hexadecimal).
The fifth argument A₅ is a client preference field, one byte in length, that may indicate if the pluggable component is made by a preferred supplier (0x01) or not (0x00).
The sixth argument A₆ is a time value of when the pluggable component is first detected by the system management represented in Universal Time Coordinated (UTC) format (e.g., Tuesday, Mar. 26, 2013 7:28:28 or 0x5151F6DC in hexadecimal).

It may be appreciated that the above six arguments are examples of data that may be used to generate a pairing signature. Different data may also be used and arguments above (e.g., client preference field) may be omitted or other arguments added. However, based on the above example, the checksum may then be calculated as follows:

Checksum=0x(4C+33+43+46+4B+36+4C)XOR0x(36+34+37+34)XOR 0x(36+38+59+37+33+38+31)XOR0x(46+43+32+30+32+37+34+30+30+35)=(0x1D5)XOR(0xD5)XOR(0x19A)XOR(0x21D)=0x287

Then the encryption key may be determined. With respect to the above example, the encryption key may be the sum of the three letters IBM in hexadecimal. As such, the calculation for the encryption key in this example may be as follows:

Encryption Key=(I+B+M)=(0x49+0x42+0x4D)=0xD8

Next, continuing with the above example, the pairing signature may be calculated using the checksum and encryption key results as follows:

Pairing Signature=(0x287*0xD8)+0x01+0x5151F6DC=0x515418C5

Next, at 216, the pairing signature may be stored in both the persistent memory of the pluggable component and the persistent memory of the electronic device. As such, with respect to future boot events associated with the electronic device, the present embodiment may determine whether the pluggable component was present at the previous electronic device boot by matching the pairing signature from the pluggable component with a pairing signature stored in the electronic device. An example of the pluggable component's persistent memory may be a ROM chip soldered to the circuit board of the pluggable component. Persistent memory of the electronic device may include, for example, a ROM chip or a hard disk drive. According to at least one embodiment, a pluggable device may retain previous pairing signatures. Furthermore, pairing signatures may also be decrypted later. For example, pairing signatures may be decrypted later so that service personnel may determine in which electronic devices the pluggable component has been installed in previously, if any.

In response to creating the pairing signature at 216, an alert is logged at 218, to record the presence of a new pluggable component in the device. An alert may also be logged at 218 after the process 200 checks if the VPD is valid for the pluggable component at 210. For example, an alert noting that a non-compliant pluggable component has been discovered may be logged in a system event log (SEL) stored on the electronic device. According to at least one implementation, the alert may contain a copy of all, or parts, of the pluggable component's VPD (e.g., serial number, part number, etc.). Additionally, the alert may trigger a call home event where a copy of the electronic device's information and system logs may be sent out to the manufacturer via a network to notify the manufacturer of a potential hardware issue when it is first detected.

Next at 220, the system management software is updated with the pluggable component's information. For example, the system management software may be updated with information corresponding to the pluggable component such as the current time, the hardware ID associated with the pluggable component, and the status of the pluggable component (e.g., has the pluggable component been tampered with, is it a valid component, hardware errors such as bad memory sectors), etc. The system management software may be, for example, located on a system management chip attached to the electronic device's planar.

Then, at 222, it is determined whether all pluggable components have been analyzed. If at 222, it is determined that all pluggable components have not been analyzed, then the process 200 may return to 202 to analyze the next pluggable component. However, if at 222, it is determined that all pluggable components have been analyzed, then the process 200 may conclude.

FIG. 3 shows a block diagram 300 of the exemplary components of a data processing system 800, 900 that may execute the pluggable component tracking program 108A and 108B (FIG. 1) in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) may each include respective sets of internal components 800a, b and external components 900a, b illustrated in FIG. 3. Each of the sets of internal components 800a, b includes one or more processors 820, one or more computer-readable RAMs 822 and one or more computer-readable ROMs 824 on one or more buses 826, and one or more operating systems 828 and one or more computer-readable tangible storage medium 830. The one or more operating systems 828 and programs such as a pluggable component tracking program given by processes 200 (FIG. 2), may be stored on one or more computer-readable tangible storage medium 830 for execution by one or more processors 820 via one or more RAMs 822 (which typically include cache memory). In the embodiment illustrated in FIG. 3, each of the computer-readable tangible storage medium 830 is a magnetic disk storage device of an internal hard drive. Alternatively, each of the computer-readable tangible storage medium 830 is a semiconductor storage device such as ROM 824, EPROM, flash memory or any other computer-readable tangible storage device that can store a computer program and digital information.

Each set of internal components 800a, b also includes a R/W drive or interface 832 to read from and write to one or more portable computer-readable tangible storage devices 936 such as a CD-ROM, DVD, memory stick, magnetic tape, magnetic disk, optical disk or semiconductor storage device. The pluggable component tracking program associated with the pluggable component tracking program 108A and 108B (FIG. 1) can be stored on one or more of the respective portable computer-readable tangible storage medium 936, read via the respective R/W drive or interface 832 and loaded into the respective hard drive 830.

Each set of internal components 800a, b may also include network adapters (or switch port cards) or interfaces 836 such as a TCP/IP adapter cards, wireless wi-fi interface cards, or 3G or 4G wireless interface cards or other wired or wireless communication links. The pluggable component tracking program 108A (FIG. 1) in client computer 102 and the pluggable component tracking program 108B (FIG. 1) in network server computer 112 can be downloaded from an external computer (e.g., server) via a network (for example, the Internet, a local area network or other, wide area network) and respective network adapters or interfaces 836. From the network adapters (or switch port adaptors) or interfaces 836, the pluggable component tracking program 108A (FIG. 1) in client computer 102 and the pluggable component tracking program 108B (FIG. 1) in network server computer 112 are loaded into the respective hard drive 830. The network may comprise copper wires, optical fibers, wireless transmission, routers, firewalls, switches, gateway computers and/or edge servers.

Each of the sets of external components 900a, b can include a computer display monitor 920, a keyboard 930, and a computer mouse 934. External components 900a, b can also include touch screens, virtual keyboards, touch pads, pointing devices, and other human interface devices. Each of the sets of internal components 800a, b also includes device drivers 840 to interface to computer display monitor 920, keyboard 930 and computer mouse 934. The device drivers 840, R/W drive or interface 832 and network adapter or interface 836 comprise hardware and software (stored in storage medium 830 and/or ROM 824).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for tracking a pluggable component associated with an electronic device, the method comprising:
identifying at least one field of vital product data (VPD) information associated with the pluggable component;
decoding the at least one field of VPD information;
determining, based on the decoding of the at least one field, when a hardware id associated with the pluggable component is valid; and
generating a pairing signature based on the hardware id being valid.

2. The method of claim 1, further comprising:
recording the generated pairing signature.

3. The method of claim 1, wherein the decoding of the at least one field of VPD information comprises determining whether the pluggable component was present during a last boot of the electronic device.

4. The method of claim 2, wherein the recording the generated pairing signature comprises a storing of the generated pairing signature in a persistent memory associated with the pluggable component.

5. The method of claim 2, wherein the recording the generated pairing signature comprises a storing of the generated pairing signature in a persistent memory associated with the electronic device.

6. The method of claim 1, wherein the determining when a hardware id is associated with the pluggable component is valid comprises determining when the at least one field of VPD information is valid.

7. The method of claim 6, wherein the determining when the at least one field of VPD information is valid comprises comparing the at least one field of VPD information against a list of invalid VPD information.

8. The method of claim 1, wherein the determining when a hardware id associated with the pluggable hardware is valid comprises comparing the hardware id against a list of valid hardware id information.

9. The method of claim 1, wherein the generated pairing signature comprises information to identify the pluggable component and information to identify the electronic device associated with the pluggable component.

10. A computer system for tracking a pluggable component associated with an electronic device, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
indentifying at least one field of vital product data (VPD) information associated with the pluggable component;
decoding the at least one field of VPD information;
determining, based on the decoding of the at least one field, when a hardware id associated with the pluggable component is valid; and
generating a pairing signature based on the hardware id being valid.

11. The computer system of claim 10, further comprising:
recording the generated pairing signature.

12. The computer system of claim 10, wherein the decoding of the at least one field of VPD information comprises determining whether the pluggable component was present during a last boot of the electronic device.

13. The computer system of claim 11, wherein the recording the generated pairing signature comprises a storing of the generated pairing signature in a persistent memory associated with the pluggable component.

14. The computer system of claim 11, wherein the recording the generated pairing signature comprises a storing of the generated pairing signature in a persistent memory associated with the electronic device.

15. The computer system of claim 10, wherein the determining when a hardware id is associated with the pluggable component is valid comprises determining when the at least one field of VPD information is valid.

16. The computer system of claim 15, wherein the determining when the at least one field of VPD information is valid comprises comparing the at least one field of VPD information against a list of invalid VPD information.

17. The computer system of claim 10, wherein the determining when a hardware id associated with the pluggable hardware is valid comprises comparing the hardware id against a list of valid hardware id information.

18. The computer system of claim 10, wherein the generated pairing signature comprises information to identify the pluggable component and information to identify the electronic device associated with the pluggable component.

19. A computer program product for tracking a pluggable component associated with an electronic device, comprising:
one or more computer-readable storage medium and program instructions stored on at least one of the one or more tangible storage medium, the program instructions executable by a processor, the program instructions comprising:
program instructions to identify at least one field of vital product data (VPD) information associated with the pluggable component;
program instructions to decode the at least one field of VPD information;
program instructions to determine, based on the decoding of the at least one field, when a hardware id associated with the pluggable component is valid; and
program instructions to generate a pairing signature based on the hardware id being valid.

20. The computer program product of claim 19, further comprising:
program instructions to record the generated pairing signature.
